(19) United States
(12) Patent Application Publication
(10) Pub. No.: US 2009/0074321 A1
(43) Pub. Date: Mar. 19, 2009

(54) IMAGE PROCESSING APPARATUS AND IMAGE PROCESSING METHOD

(75) Inventor: Nobuhiko Nakahara, Shizuoka-shi (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/207,274

(22) Filed: Sep. 9, 2008

Related U.S. Application Data
(60) Provisional application No. 60/972,484, filed on Sep. 14, 2007.

(51) Int. Cl. G06K 9/40

(52) U.S. Cl. 382/266

(57) ABSTRACT

An image processing apparatus according to the invention includes a peculiarity detector which detects a peculiarity and forcedly changes a flag as a base of filter selection; and a line adjustment processing selection table 208 which outputs cnt_b corresponding to patterns of lcount0 to lcount3 in accordance with a table stored in advance. More precise line thinning is controlled by the output of cnt_b.

### CROSS-REFERENCE TO RELATED APPLICATION

This application is based upon and claims the benefit of priority from the prior the U.S.A. Patent Application No. 60/972,484, filed on 14 Sep., 2007, the entire contents of which are incorporated herein by reference.

### TECHNICAL FIELD

The present invention relates to an image processing apparatus and an image formation processing method used in an image forming apparatus such as a printer or a multi-function image forming apparatus (hereinafter, referred to as MFP) and to a printer and the MFP employing the image processing apparatus and the image formation processing method.

### BACKGROUND

A known image processing apparatus performs line thinning to reduce a print area by precisely shaping a contour part of an image to be formed. The line thinning provides an advantage that an amount of consumed developer such as toner can be reduced. Therefore, for the purpose of reducing the consumption of the developer, the line thinning was developed (for example, US Unexamined Publication No. US2005/0073723 A1).

This technique is an effective method of reducing degradation of a print quality in a case of a resolution of about 6000 dpi.

In recent years, however, an image forming apparatus capable of realizing a high resolution was developed. Accordingly, if the known method is simply applied to the high resolution image forming apparatus, various problems may occur.

FIG. 16A is an exemplary diagram illustrating an image before the line thinning is performed with 600 dpi. When the line thinning is performed to delete one pixel in the right and left sides of a line, the line shown in FIG. 16B is formed. The hatched part indicates the deleted part.

FIG. 16C is an exemplary diagram illustrating an image before the line thinning is performed with 1200 dpi. When the image is subjected to the line thinning with 600 dpi, the line shown in FIG. 16D is formed. In this way, when the known line thinning is simply applied, an amount of the line thinning is reduced by half, and thus the advantage of the line thinning cannot be satisfactorily obtained.

Accordingly, when the number of deleted pixels is doubled in order to solve this problem, the line shown in FIG. 16E is formed. When a line having a sufficient width is subjected to the line thinning such as in FIG. 16E, a problem does not occur. However, when four pixels are deleted from the line having five pixels, for example, the line subjected to the line thinning has just one pixel and thus becomes too thin.

In order to solve this problem, a method of setting a threshold value of the number of pixels is taken into consideration to appropriately perform the line thinning. That is, a process of controlling the line thinning on a line having six or more pixels can be used. In this case, however, there occurs a problem in that when four pixels are deleted from the line having six pixels, just two pixels remain and thus the line becomes thinner than a line having five pixels which is not subjected to the line thinning.

Accordingly, in order to solve this problem, it is necessary to control an amount of the line thinning more precisely such as in FIG. 16F, for example.

### SUMMARY

It is an object of the present invention to provide an image processing apparatus capable of realizing line thinning more precisely. In an aspect of the present invention, an image processing apparatus includes: a contour pixel extraction section which determines whether an attention pixel is a contour; a line thinning calculation section which calculates an amount of line thinning performed on the attention pixel when the contour pixel extraction section determines that the attention pixel is the contour; a rectangular area connectivity determination section which determines whether a pixel area containing the attention pixel is a predetermined pixel pattern; and a selective correction output section which performs the line thinning on the attention pixel by the amount of line thinning when the rectangular area connectivity determination section determines that the pixel area containing the attention pixel is not the predetermined pixel pattern, and performs the line thinning on the attention pixel by an alternative amount of line thinning different from the amount of line thinning when the rectangular area connectivity determination section determines that the pixel area containing the attention pixel is the predetermined pixel pattern.

### DESCRIPTION OF THE DRAWINGS

FIG. 1 is a block diagram illustrating an overview of a rectangular area connectivity determination section 15.

FIG. 2A is a diagram illustrating a method of processing connectivity determination.

FIG. 2B is a diagram illustrating an example in which values of all pixels of a row to be determined are 1.

FIG. 2C is a diagram illustrating an example in which some white pixels are present in a row to be determined.

FIG. 3 is a diagram illustrating an example in which one side of a rectangular area determination window wc1 has thirteen pixels.

FIG. 4 is a flowchart illustrating a sequence of calculating cnt_b of a row unit connectivity count 202.

FIG. 5 is a diagram illustrating a determination method of an upper side connectivity determiner 204.

FIG. 6 is a diagram illustrating a determination method of a lower side connectivity determiner 205.

FIG. 7 is a diagram illustrating a determination method of a left side connectivity determiner 206.

FIG. 8 is a diagram illustrating a determination method of a right side connectivity determiner 207.

FIG. 9 is a diagram illustrating a circular dot expressed in an image processing window Wa.

FIG. 10 is a diagram illustrating a result of the line thinning performed on the drawing of FIG. 9 by a known method.

FIG. 11A is a diagram illustrating examples of peculiarity patterns of cnt_b.

FIG. 11B is a diagram illustrating a result of the line thinning in accordance with an output of the peculiarity detector 211.

FIG. 12 is a diagram illustrating a connection operation of a flag connection section 16.

FIG. 13 is a diagram illustrating an example of filter selection of a selector 141.

FIG. 14 is a block diagram illustrating an overview of a rectangular area connectivity determination section 15.

FIG. 15 is a block diagram illustrating an overview of a rectangular area connectivity determination section 15.

FIG. 16A is an exemplary diagram illustrating an image before the line thinning is performed with 600 dpi

FIG. 16B is a diagram illustrating an example in which the line thinning is performed to delete one pixel in the right and left sides of a line shown in FIG. 16A.

FIG. 16C is an exemplary diagram illustrating an image before the line thinning is performed with 1200 dpi.

FIG. 16D is a diagram illustrating an example in which a line shown in FIG. 16C is subjected to the line thinning with 600 dpi.

FIG. 16E is a diagram in which the number of pixels to be deleted is doubled.

FIG. 16F is a diagram in which the line thinning is controlled more precisely.

FIG. 17 is a diagram illustrating a hardware configuration of the image processing apparatus according to an embodiment.

FIG. 18 is a flowchart illustrating a process overview of the image processing apparatus according to the embodiment.

FIG. 19 is a block diagram related to the line thinning in the image processing apparatus.

FIG. 20 is a conceptual diagram illustrating the image processing window Wa.

FIG. 21 is a diagram illustrating an original image 41 as an example of an image to be printed which is not subjected to the line thinning.

FIG. 22 is a diagram illustrating an example in which the image processing window Wa is set by matching the original image 41 with an attention pixel 33.

FIG. 23 shows examples of the contour pattern.

FIG. 24 is a flowchart illustrating a process of a contour pixel extraction section 11.

### DETAILED DESCRIPTION

Throughout this description, the embodiments and examples shown should be considered as exemplars, rather than limitations on the apparatus and methods of the present invention.

Hereinafter, an image processing apparatus according to embodiments will be described in detail with reference to the drawings.

### First Embodiment

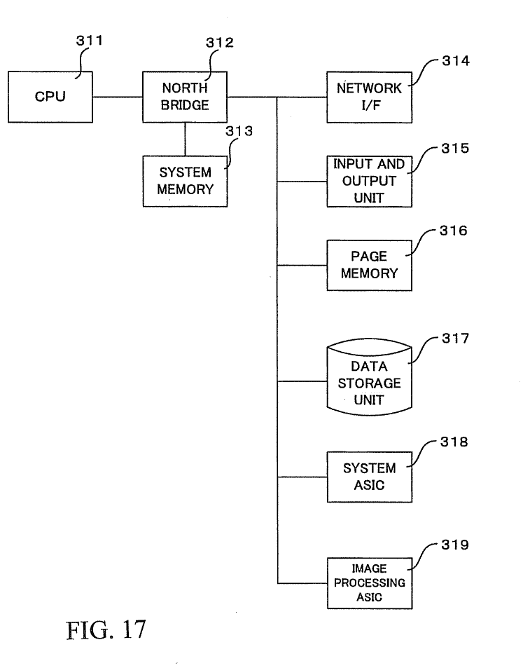

FIG. 17 is a diagram illustrating a hardware configuration of the image processing apparatus according to this embodiment. As shown in FIG. 17, the image processing apparatus includes an arithmetic device CPU 311, a north bridge 312 connected to the CPU 311, and a system memory 313 connected to the north bridge 312.

The north bridge 312 is connected to a network interface 314, an input and output unit 315, a page memory 316, a data storage unit 317, a system ASIC 318, and an image processing ASIC 319 which is an ASIC performing image processing.

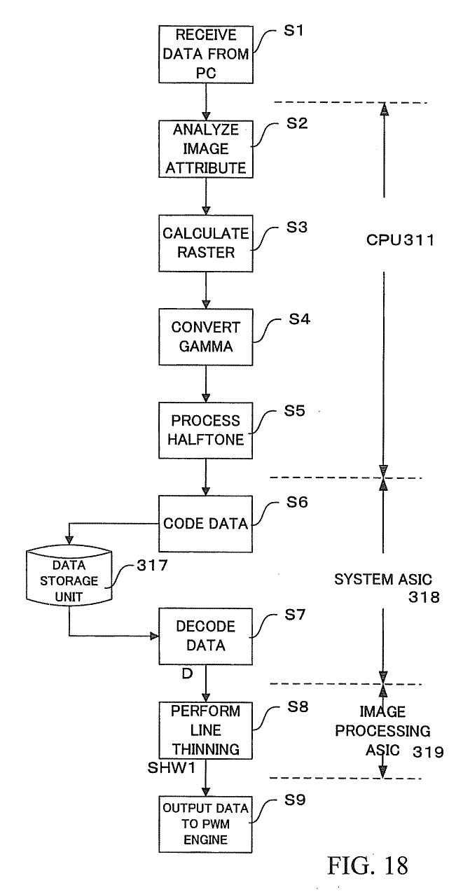

FIG. 18 is a flowchart illustrating a process overview of the image processing apparatus according to this embodiment. As shown in FIG. 18, the image processing apparatus receives data to be printed from an apparatus such as a personal computer in Act S1.

The image processing apparatus analyzes an image attribute in Act S2 and classifies the data to be printed into Text, Graphics, and photo. The image processing apparatus calculates a raster in Act S3, converts gamma in Act S4, and performs a halftone process in Act S5.

The processes from Acts S2 to S5 are performed by the CPU 311 using a software program.

The image processing apparatus codes data in Act S6 and sequentially stores the coded data in the data storage unit 317. The image processing apparatus sequentially reads and decodes the stored data in Act S7. The processes from Acts S6 and S7 are performed by the system ASIC 318.

The image processing apparatus performs line thinning in Act S8 and output the data subjected to the line thinning to a PWM engine in Act S9. The process in Act S8 is performed by the image processing ASIC 319.

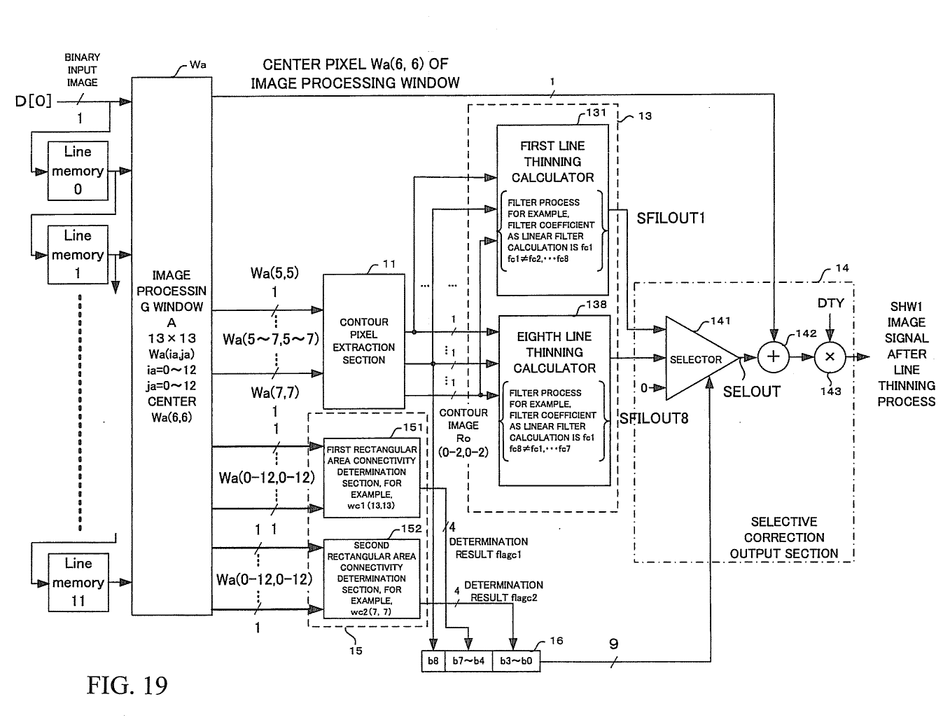

FIG. 19 is a block diagram related to the line thinning in the image processing apparatus. As shown in FIG. 19, the image processing apparatus includes an image processing window Wa, a contour pixel extraction section 11, a rectangular area connectivity determination section 15, a line thinning calculation section 13, and a selective correction output section 14.

The image processing window Wa outputs a signal to the contour pixel extraction section 11 and the rectangular area connectivity determination section 15. The contour pixel extraction section 11 outputs a signal to the line thinning calculation section 13. The line thinning calculation section 13 and the rectangular area connectivity determination section 15 output signals to the selective correction output section 14. Hereinafter, the above sections will be described.

### (Image Processing Window)

The image processing window Wa is a storage area of a two-dimensional image signal containing target pixels. Generally, the two-dimensional image signal is input to the image processing window Wa from the outside. However, when one-dimensional signal is input, plural line memories having a storage capacity of a main scanning width or more of an image temporarily store the one-dimensional signal and the image processing window Wa refers the one-dimensional signal as the two-dimensional signal. In this embodiment, a signal level indicating a black image of a binary image signal is set to “1” and a signal level indicating a white image of the binary image signal is set to “0”.

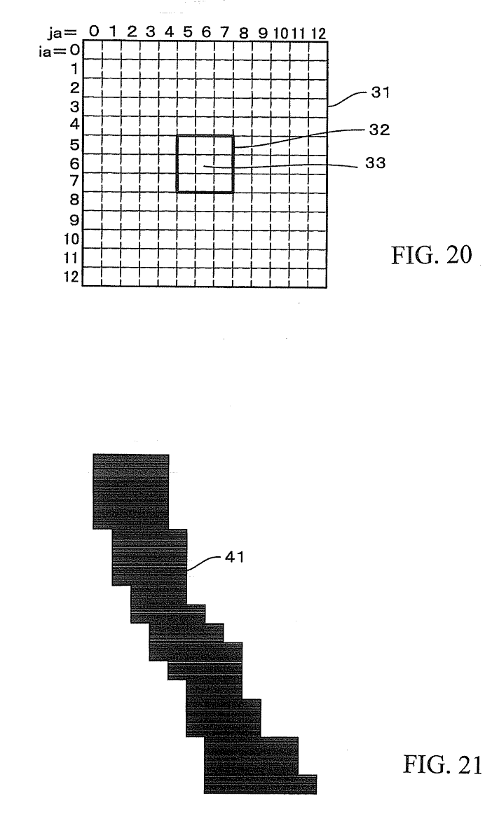

FIG. 20 is a conceptual diagram illustrating the image processing window Wa. As shown in FIG. 20, the image processing window Wa can be expressed as a square of which one side has an odd number of pixels. In FIG. 20, the image processing window Wa of which one side has thirteen pixels is illustrated, but the size of one side is not limited thereto.

On the assumption that a main scanning direction is ja, a sub-scanning direction is ia, and a left upper part is Wa(0, 0), an attention pixel 33 is Wa(6, 6).

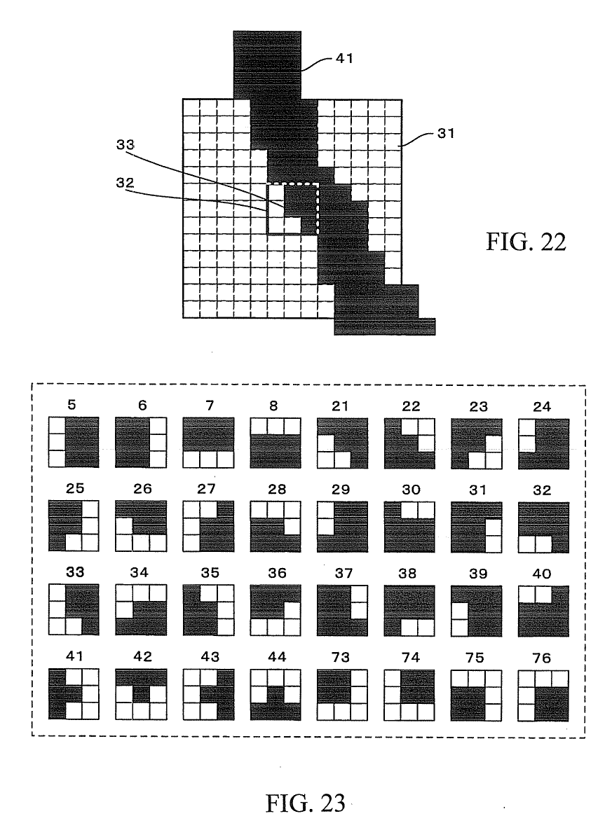

FIG. 21 is a diagram illustrating an original image 41 as an example of an image to be printed which is not subjected to the line thinning. FIG. 22 is a diagram illustrating an example in which the image processing window Wa is set by matching the original image 41 with the attention pixel 33. As shown in FIG. 22, the image processing apparatus sequentially scans the original image 41 using the image processing window Wa.

### (Contour Pixel Extraction Section)

The contour pixel extraction section 11 determines whether the attention pixel 33 is a contour. The contour pixel extraction section 11 determines whether the attention pixel 33 is the contour by pattern matching, for example.

The image processing window Wa outputs a contour pixel extraction window 32 to the contour pixel extraction section 11. The contour pixel extraction window 32 is a square area which contains the attention pixel 33 of the image processing window Wa at the center and of which one side has an odd number of pixels. For example, one side is set to have three pixels. An example of the contour pixel extraction window 32 is illustrated in FIGS. 20 and 22. In this case, the contour pixel extraction window 32 contains Wa(5, 5) to Wa(7, 7).

The contour pixel extraction section 11 stores a contour pattern and takes a logical AND of the contour pattern and the contour pixel extraction window 32.

FIG. 23 shows examples of the contour pattern. As shown in FIG. 23, the contour pixel extraction section 11 stores plural examples of the contour pattern where the attention pixel 32 is the contour. The contour pixel extraction window 32 is the same as a thirty-third contour pattern among the examples of FIG. 22. When the same contour pattern is present, the contour pixel extraction section 11 outputs “1”. Alternatively, when the same contour pattern is not present, the contour pixel extraction section 11 outputs “0” as a determination result Ro.

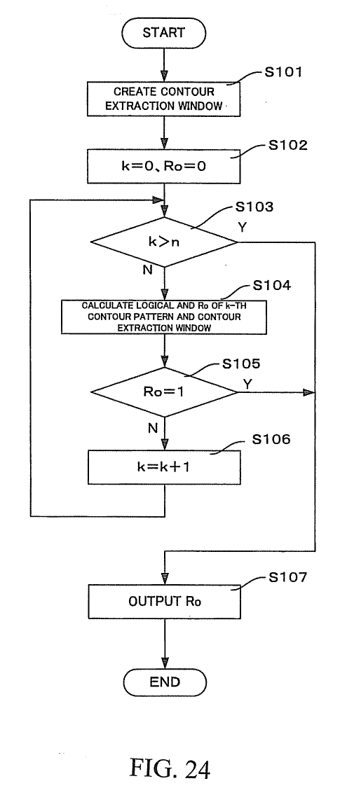

FIG. 24 is a flowchart illustrating a process of the contour pixel extraction section 11. As shown in FIG. 24, the contour pixel extraction section 11 creates a contour extraction window in Act S101 and initializes a counter k and the determination result Ro to 0 in Act S102.

The contour pixel extraction section 11 determines whether the counter k exceeds the number of contour patterns n in Act S103. When a condition of k>n is satisfied, the process proceeds to Act S107. Alternatively, when the condition of k>n is not satisfied, the process proceeds to Act S104.

In Act S104, the contour pixel extraction section 11 calculates the logical AND of a k-th contour pattern and the contour pixel extraction window 32 and calculates the logical AND as the determination result Ro. The contour pixel extraction section 11 determines whether the determination result Ro is 1 in Act S105. When a condition of Ro=1 is satisfied, the contour pixel extraction section 11 permits the process to proceed to Act S107. Alternatively, the condition of Ro=1 is not satisfied, the process proceeds to Act S106.

The contour pixel extraction section 11 adds 1 to the counter k in Act S106 and the process returns to Act S103. The contour pixel extraction section 11 outputs the determination result Ro in Act S107.

### (Rectangular Area Connectivity Determination Section)

The rectangular area connectivity determination section 15 determines connectivity in a rectangular area determination window wc and outputs the result. The rectangular area determination window wc can be expressed as a square which contains the attention pixel 33 of the image processing window Wa at the center and of which one side has an odd number of pixels. One side of the rectangular area determination window wc can use areas having different sizes such as seven pixels or thirteen pixels.

In this embodiment, a first rectangular area connectivity determination section 151 uses a rectangular area determination window wc1 of which one side has thirteen pixels and a second rectangular area connectivity determination section 152 uses a rectangular area determination window wc2 of which one side has seven pixels.

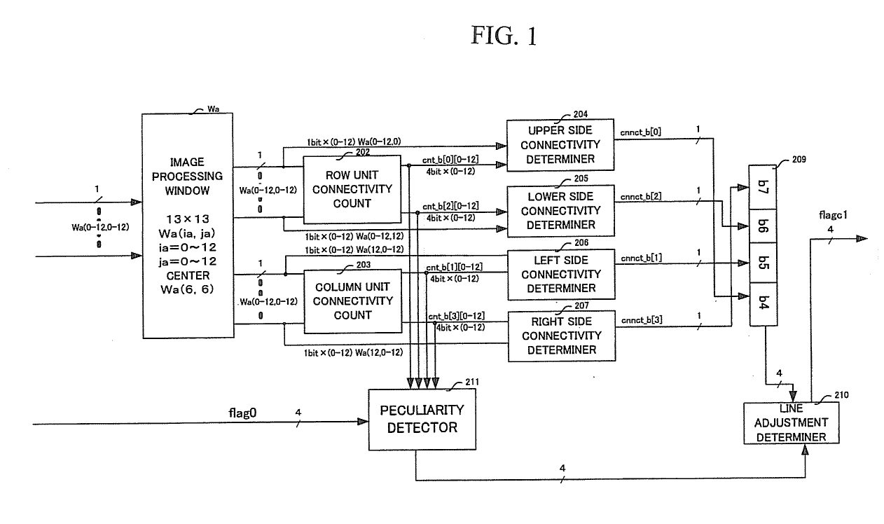

FIG. 1 is a block diagram illustrating an overview of the rectangular area connectivity determination section 15. The first rectangular area connectivity determination section 151 has the same configuration as that of the second rectangular area connectivity determination section 152, except that the size of the rectangular area connectivity determination window wc1 is different from that of the rectangular area connectivity determination window wc2. Hereinafter, the first rectangular area connectivity determination section 151 will be described as an example.

As shown in FIG. 1, the first rectangular area connectivity determination section 151 includes a row unit connectivity count 202, a column unit connectivity count 203, an upper side connectivity determiner 204, a lower side connectivity determiner 205, a left side connectivity determiner 206, a right side connectivity determiner 207, a line adjustment determiner 210, and a peculiarity detector 211. Hereinafter, the above elements will be described.

### (Row Unit Connectivity Count and Column Unit Connectivity Count)

The row unit connectivity count 202 inputs a signal from the image processing window Wa. The row unit connectivity count 202 determines connectivity of rows from the input signal and outputs the result.

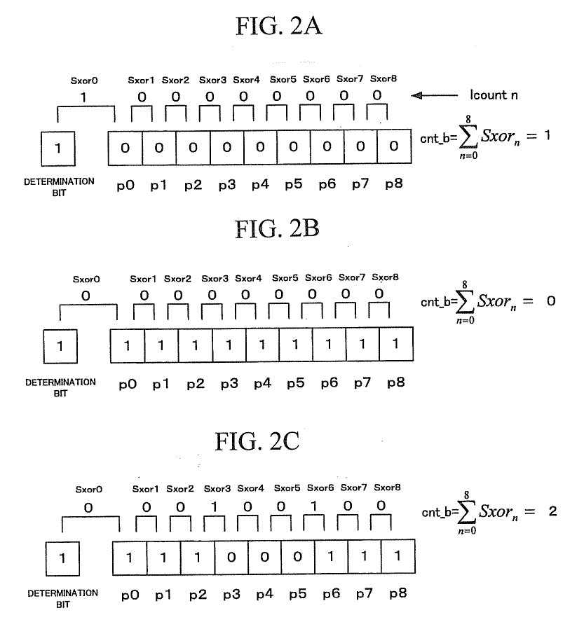

FIG. 2A is a diagram illustrating a method of processing connectivity determination. In FIGS. 2A to 2C, a determination bit which is a bit value set in advance is set to 1 upon performing the line thinning. A first row of the rectangular area determination window wc1 is indicated by p0 to p8. In this case, one side of the rectangular area determination window wc1 has nine pixels.

The row unit connectivity count 202 calculates xor of a priority determination bit and p0, where xor refers to an exclusive OR. That is, a value of A xor B is 0 when A=B and 1 when A#B.

Sxor0 which is xor of the determination bit and p0 is 1, since the determination bit is 1 and p0 is 0.

The row unit connectivity count 202 calculates Sxor1 which is xor of the p0 and p1. Sxor1 is 0 since p0 is 0 and p1 is 0.

The row unit connectivity count 202 repeats this calculation to calculate nine values of Sxor.

A calculation of cnt_b which is a sum of the calculated nine values of Sxor is executed. In an example of FIG. 2A, cnt_b is 1.

FIG. 2B is a diagram illustrating an example in which values of all pixels of a row to be determined are 1. As shown in FIG. 2B, every Sxor is 0 when all the pixels of the row to be determined are 1. Accordingly, cnt_b is 0.

FIG. 2C is a diagram illustrating an example in which some white pixels are present in a row to be determined. As shown in FIG. 2C, cnt_b is 2 since p2 xor p3 and p5 xor p6 are 1, respectively.

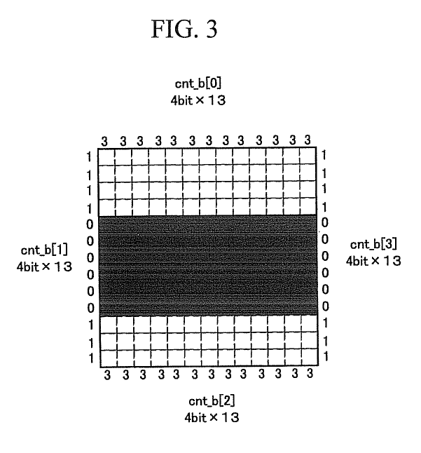

FIG. 3 is a diagram illustrating an example in which one side of the rectangular area determination window wc1 has thirteen pixels. As shown in FIG. 3, the row unit connectivity count 202 calculates thirteen values of cnt_b[0] from the upper side to the lower side and calculates thirteen values of cnt_b[2] from the lower side to the upper side.

In the example of FIG. 3, a horizontal line having six-pixel width is illustrated. In this case, cnt_b[0] and cnt_b[2] are all 3. In addition, cnt_b[1] and cnt_b[3] are 0 in line parts and 1 in parts other than the line parts.

The row unit connectivity count 202 outputs the calculated value of cnt_b[0] and the calculated value of cnt_b[2] to the upper side connectivity determiner 204 and the lower side connectivity determiner 205, respectively. By the same operation of the row unit connectivity count 202, the column unit connectivity count 203 calculates thirteen values of cnt_b [1] from the left side to the right side and then calculates thirteen values of cnt_b[3] from the right side to the left side.

The column unit connectivity count 203 outputs the calculated value of cnt_b[1] and the calculated value of cnt_b[3] to the left side connectivity determiner 206 and the right side connectivity determiner 207, respectively.

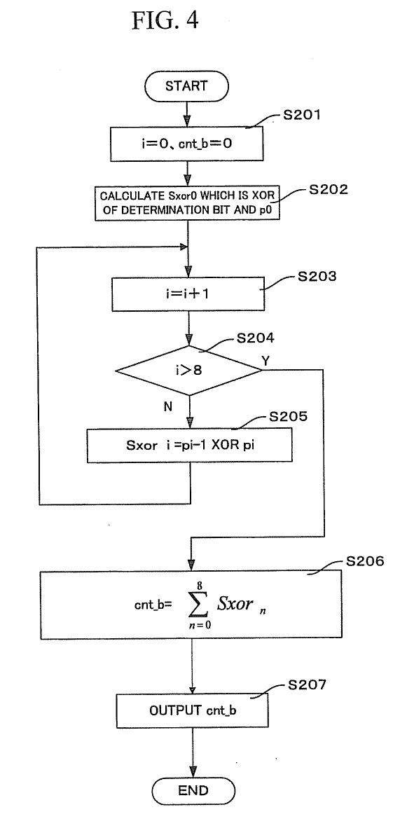

FIG. 4 is a flowchart illustrating a sequence of calculating values of cnt_b in the row unit connectivity count 202. As shown in FIG. 4, in Act S201, the row unit connectivity count 202 initializes a counter i and cnt_b to 0, respectively. In Act S202, the row unit connectivity count 202 calculates Sxor0 which is xor of the determination bit and p0.

In Act S203, the row unit connectivity count 202 adds 1 to the counter i. In Act S204, the row unit connectivity count 202 determines whether the counter i is larger than 8. The value of 8 is a value when one side of the rectangular area determination window wc1 has nine pixels. For example, the value is 12 when one side of the rectangular area determination window wc1 has thirteen pixels. The row unit connectivity count 202 permits the process to proceed to Act S206 when a condition of i>8 is satisfied. Alternatively, when the condition of i>8 is not satisfied, the process proceeds to Act S205.

In Act S205, the row unit connectivity count 202 calculates xor of pi−1 as an (i−1)-th pixel and pi as an i-th pixel and substitutes a value with Sxori which is an i-th Sxor. Then, the process returns to Act S203.

In Act S206, the row unit connectivity count 202 calculates a sum from a 0-th Sxor to an 8-th Sxor and substitutes a value with cnt_b. In Act S207, the row unit connectivity count 202 outputs cnt_b.

The row unit connectivity count 202 repeatedly performs the processes of Act S201 to Act S207 by the number of pixels of one side in the rectangular area determination window wc1, calculates 4-bit cnt_b by the number of the pixels of one side in the rectangular area determination window wc1, and then outputs the value to the upper side connectivity determiner 204.

In addition, the row unit connectivity count 202 repeatedly performs the processes of Act S201 to Act S207 by the number of the pixels of one side in the rectangular area determination window wc1 from the lower side to the upper side of the rectangular area determination window wc1, calculates 4-bit cnt_b by the number of the pixels of one side in the rectangular area determination window wc1, and then outputs the calculated value to the lower side connectivity determiner 205.

The column unit connectivity count 203 performs the cnt_b calculating operation of the row unit connectivity count 202 from the left side to the right side of the rectangular area determination window wc1 and outputs the calculated value to the left side connectivity determiner 206. In addition, the column unit connectivity count 203 performs the cnt_b calculating operation from the right side to the left side of the rectangular area determination window wc1 and outputs the calculated value to the right side connectivity determiner 207.

### (Connectivity Determiner)

The upper side connectivity determiner 204, the lower side connectivity determiner 205, the left side connectivity determiner 206, and the right side connectivity determiner 207 each input cnt_b, determine the connectivity, and output cnnct_b as the determination result.

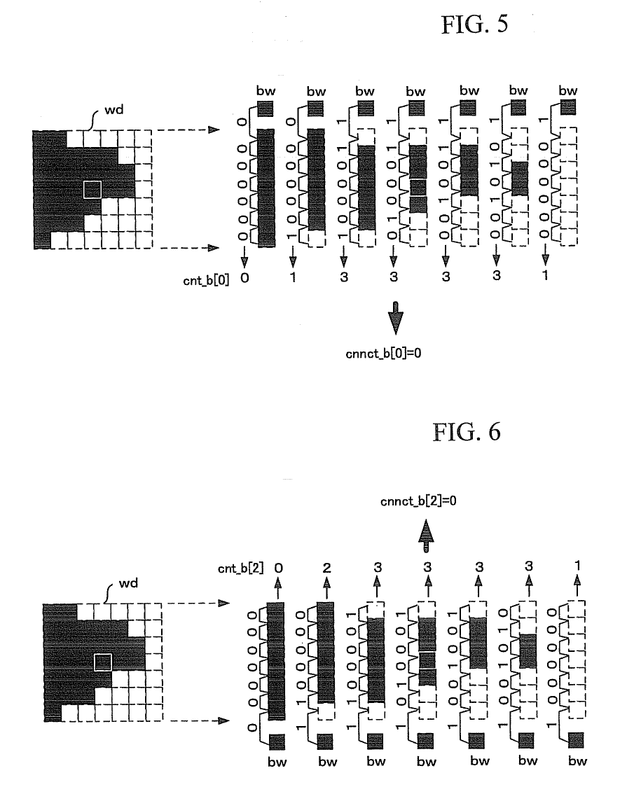

FIG. 5 is a diagram illustrating a determination method of the upper side connectivity determiner 204. In this case, a connectivity determination window wd is a square area containing the attention pixel 33 of the image processing window Wa at the center. One side of the connectivity determination window wd has seven pixels in FIG. 5, for example. In addition, the determination bit is indicated by bw in FIG. 5.

The upper side connectivity determiner 204 outputs cnnct_b[0]=1 as a connectivity determination value to b4 of a determination result connector 209, when the values of cnt_b are all 1 or less. The upper side connectivity determiner 204 outputs cnnct_b[0]=0 to b4 of the determination result connector 209, when at least one of the values of cnt_b is 2 or more.

In an example of FIG. 5, a value of cnnct_b[0] is 0, since cnt_b having the value of 3 is present.

FIG. 6 is a diagram illustrating a determination method of the lower side connectivity determiner 205. In this case, a connectivity determination window wd is a square area containing the attention pixel 33 of the image processing window Wa at the center. One side of the connectivity determination window wd has seven pixels in FIG. 6, for example.

The lower side connectivity determiner 205 outputs cnnct_b[2]=1 as a connectivity determination value to b6 of the determination result connector 209, when the values of cnt_b are all 1 or less. The lower side connectivity determiner 205 outputs cnnct_b[2]=0 to b6 of the determination result connector 209, when at least one of the values of cnt_b is 2 or more.

In the example of FIG. 6, a value of cnnct_b[2] is 0, since cnt_b having the value of 3 is present.

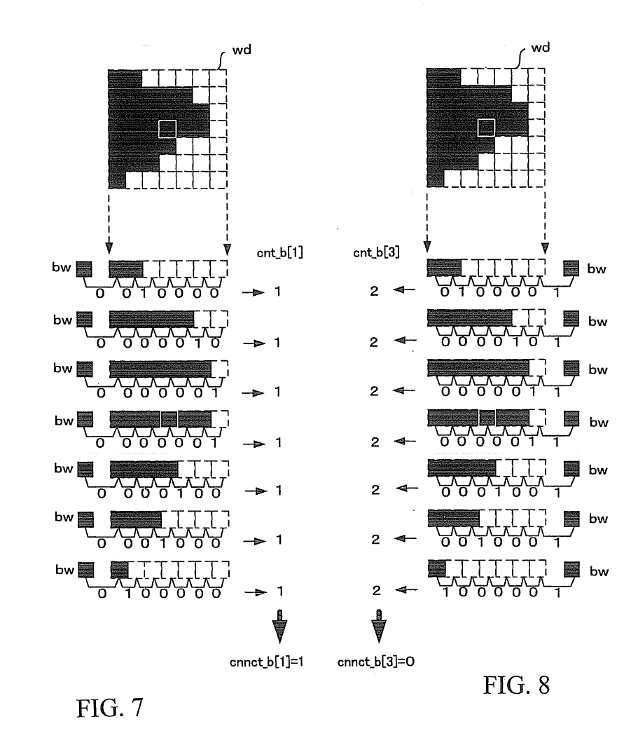

FIG. 7 is a diagram illustrating a determination method of the left side connectivity determiner 206. In this case, a connectivity determination window wd is a square area containing the attention pixel 33 of the image processing window Wa at the center. One side of the connectivity determination window wd has seven pixels in FIG. 7, for example.

The left side connectivity determiner 206 outputs cnnct_b[1]=1 as a connectivity determination value to b5 of the determination result connector 209, when the values of cnt_b are all 1 or less. The left side connectivity determiner 206 outputs cnnct_b[1]=0 to b5 of the determination result connector 209, when at least one of the values of cnt_b is 2 or more.

In the example of FIG. 7, a value of cnnct_b[1] is 1, since all the values of cnt_b are 1 or less.

FIG. 8 is a diagram illustrating a determination method of the right side connectivity determiner 207. In this case, a connectivity determination window wd is a square area containing the attention pixel 33 of the image processing window Wa at the center. One side of the connectivity determination window wd has seven pixels in FIG. 8, for example.

The right side connectivity determiner 207 outputs cnnct_b[3]=1 as a connectivity determination value to b7 of the determination result connector 209, when the values of cnt_b are all 1 or less. The right side connectivity determiner 207 outputs cnnct_b[3]=0 to b7 of the determination result connector 209, when at least one of the values of cnt_b is 2 or more.

In the example of FIG. 8, a value of cnnct_b[3] is 0, since cnt_b having the value of 2 is present.

The determination result connector 209 outputs 4-bit flagc of b4 to b7 to a line adjustment determiner 210.

### (Peculiarity Detector)

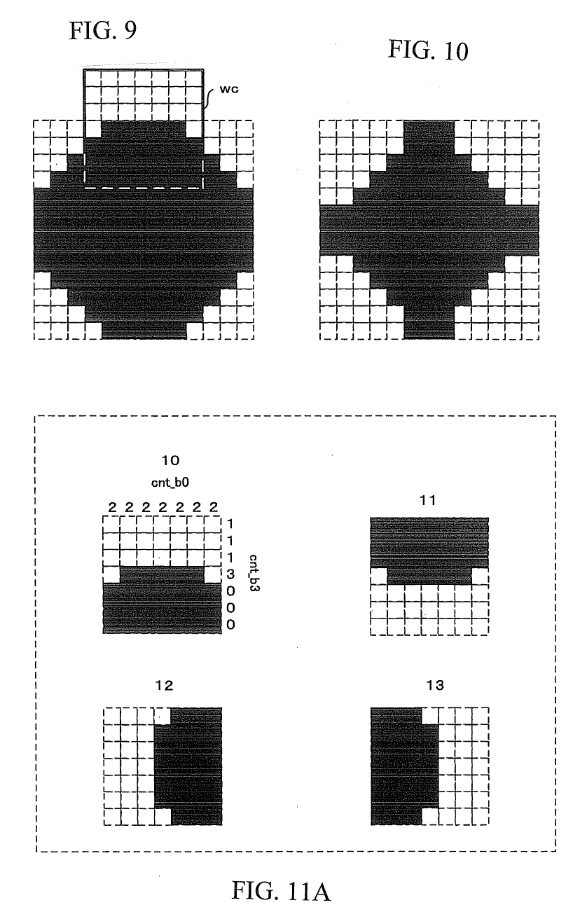

FIG. 9 is a diagram illustrating a round dot shown in the image processing window Wa. FIG. 10 is a diagram illustrating a result of the line thinning performed on the drawing of FIG. 9 by a known method. As shown in FIG. 10, a figure subjected to the line thinning by the known method does not become round and becomes protrusive in upward, downward, right, and left directions.

In this embodiment, a peculiarity of the figure in which such a phenomenon occurs is detected and flagc is forcedly switched to make the line of the figure thin more smoothly.

The row unit connectivity count 202 outputs cnt_b[0] and cnt_b[2] to the peculiarity detector 211. The column unit connectivity count 203 outputs cnt_b[1] and cnt_b[3] to the peculiarity detector 211.

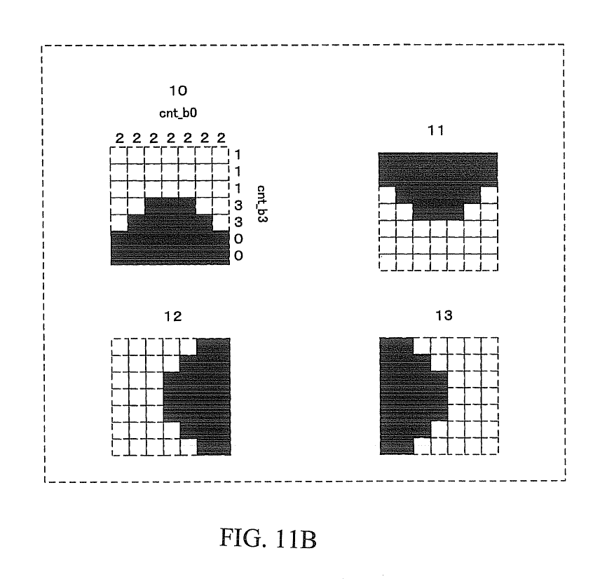

On the other hand, the peculiarity detector 211 stores peculiarity patterns which are patterns of cnt_b of the peculiarity. FIG. 11A is a diagram illustrating examples of the patterns of cnt_b of the peculiarity.

The peculiarity detector 211 sequentially reads the peculiarity patterns and compares the peculiarity patterns and cnt_b, when the peculiarity detector 211 receives an input of cnt_b. As a comparison method, the logical AND may be used.

In the example of FIG. 9, the rectangular area determination window wc1 is the same as a tenth peculiarity pattern. Accordingly, the peculiarity detector 211 determines that a peculiarity is present in the image processing window Wa.

The peculiarity detector 211 outputs predetermined flagc when the peculiarity detector 211 determines that the peculiarity is present. For example, when the peculiarity is detected, 1101 is output as flagc.

When the peculiarity detector 211 inputs the value, the line adjustment determiner 210 outputs the value output from the peculiarity detector 211 as flagc, instead of a value input from the determination result connector 209.

For example, when an input from the determination result connector 209 is 0010, the peculiarity detector 211 outputs 1101. At this time, since 1101 is higher than 0010 in terms of connectivity, the line thinning calculation section 13 described below deletes more pixels. In this way, the protruding part of the peculiarity is removed and thus becomes more smooth thin line.

FIG. 11B is a diagram illustrating the result of the line thinning in accordance with the output of the peculiarity detector 211. As shown in FIG. 11B, the tenth peculiarity pattern in FIG. 11A, an eleventh peculiarity pattern in FIG. 11A, a twelfth peculiarity pattern in FIG. 11A, and a thirteenth peculiarity pattern in FIG. 11A are subjected to the line thinning smoothly to be a tenth figure in FIG. 11B, an eleventh figure in FIG. 11B, a twelfth figure in FIG. 11B, and a thirteenth figure in FIG. 11B, respectively.

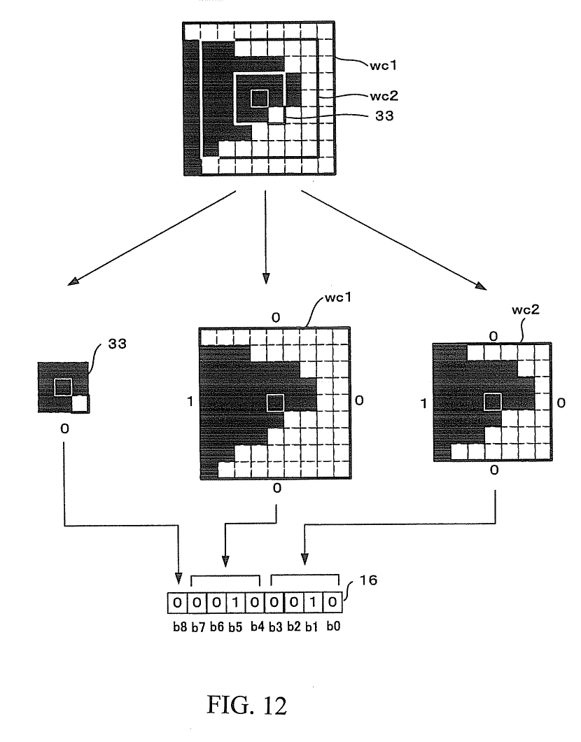

FIG. 12 is a diagram illustrating a connection operation of a flag connection section 16. As shown in FIG. 12, the flag connection section 16 sets and outputs Ro as an output from the contour pixel extraction section 11, flagc[0] as an output of flagc from the first rectangular area connectivity determination section 151, and flagc[1] as an output of flagc from the second rectangular area connectivity determination section 152 to b8, b7 to b4, and b3 to b0, respectively.

### (Line Thinning Calculation Section)

The line thinning calculation section 13 includes a first line thinning calculator 131 to an eighth line thinning calculator 138. The line thinning calculation section 13 inputs binarization values of pixels including the contour pixel extraction window 32 and creates filter coefficients in accordance with the patterns of the contour pixel extraction window 32.

The filter coefficients are different in the first line thinning calculator 131 to the eighth line thinning calculator 138. For example, the first line thinning calculator 131 to the eighth line thinning-calculator 138 create the respective filter coefficients so that the first line thinning calculator 131 to the eighth line thinning calculator 138 perform the line thinning more in sequence and output SFILOUT 1 to SFILOUT 8 as the filter coefficients to a selector 141 of the selective correction output section 14.

The selector 141 outputs 0 and SFILOUT 1 to SFILOUT 8 selectively as SELOPUT to an addition portion 142 in accordance with the input from the flag connection section 16.

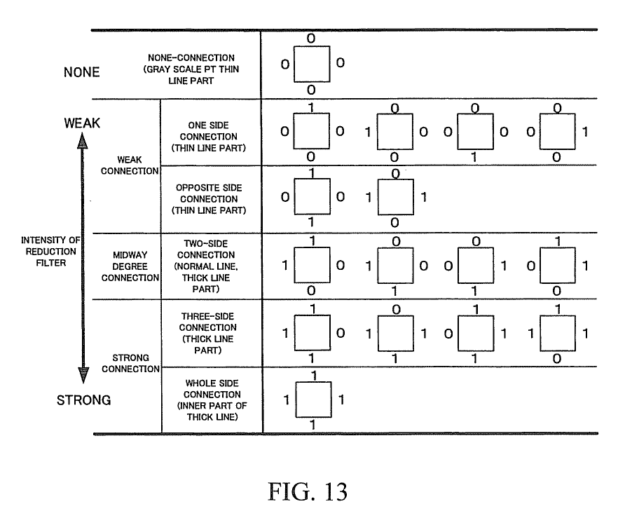

FIG. 13 is a diagram illustrating an example of filter selection of the selector 141. In FIG. 13, only flagc[0] is illustrated for convenient explanation. In addition, the number of filter coefficients is five.

As shown in FIG. 13, the selector 141 does not perform the line thinning when flagc[0] is 0000, for example, and selects the filter coefficient so as to delete more by enlarging an intensity of reduction filter when flagc[0] is 1011.

That is, the selector 141 selects the filter coefficient in such a manner of cutting a thick line part and an inner part of the thick line much, cutting a normal line by a midway degree, and cutting a thin line part a little.

The addition portion 142 adds the attention pixel 33 to SELOUT and outputs an addition of the attention pixel 33 and SELOUT to a multiplication portion 143. The multiplication portion 143 multiplies a value input from the addition portion 142 by a duty DTY to perform the line thinning and outputs the obtained value as an image signal SHW1.

### Advantage of First Embodiment

As described above, the image processing apparatus according to this embodiment includes a peculiarity detector which detects the peculiarity and forcedly changes the flag which is a base of the filter selection. Accordingly, with the image processing apparatus according to this embodiment, it is possible to obtain an advantage of performing the line thinning while keeping the feature of a figure even though the figure has a peculiarity.

### Second Embodiment

A second embodiment will be described. The same reference numerals are given to the same constituent elements as those in the first embodiment and the detailed description is omitted. A difference between this embodiment and the first embodiment is a configuration and an operation of the rectangular area connectivity determination section 15.

### (Rectangular Area Connectivity Determination Section)

The rectangular area connectivity determination section 15 determines connectivity in a rectangular area determination window wc and outputs the result. The rectangular area determination window wc can be expressed as a square which contains the attention pixel 33 of the image processing window Wa at the center and of which one side has an odd number of pixels. One side of the rectangular area determination window wc can use areas having different sizes such as seven pixels or thirteen pixels.

In this embodiment, a first rectangular area connectivity determination section 151 uses a rectangular area determination window wc1 of which one side has thirteen pixels and a second rectangular area connectivity determination section 152 uses a rectangular area determination window wc2 of which one side has seven pixels.

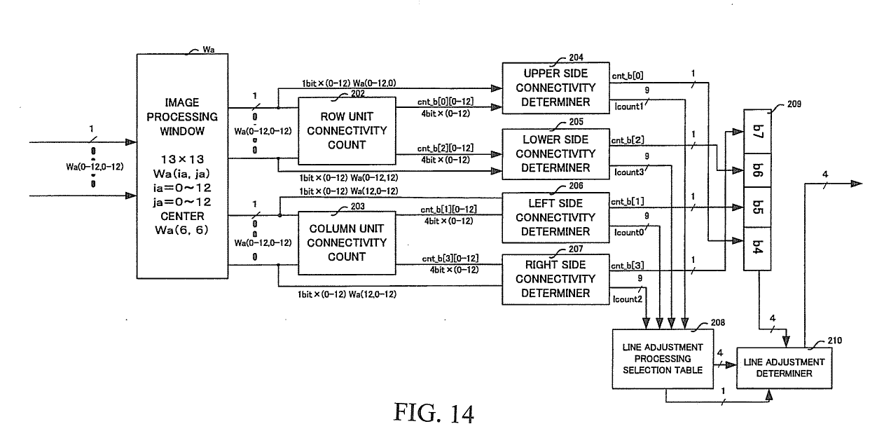

FIG. 14 is a block diagram illustrating an overview of the rectangular area connectivity determination section 15. The first rectangular area connectivity determination section 151 has the same configuration as that of the second rectangular area connectivity determination section 152, except that the size of the rectangular area connectivity determination window wc1 is different from that of the rectangular area connectivity determination window wc2. Hereinafter, the first rectangular area connectivity determination section 151 will be described as an example.

As shown in FIG. 14, the first rectangular area connectivity determination section 151 includes a row unit connectivity count 202, a column unit connectivity count 203, an upper side connectivity determiner 204, a lower side connectivity determiner 205, a left side connectivity determiner 206, a right side connectivity determiner 207, a line adjustment determiner 210, and a line adjustment processing selection table 208. Hereinafter, the above elements will be described.

### (Row Unit Connectivity Count and Column Unit Connectivity Count)

The row unit connectivity count 202 inputs a signal from the image processing window Wa. The row unit connectivity count 202 determines connectivity of rows from the input signal and outputs the result.

FIG. 2A is a diagram illustrating a method of processing connectivity determination. In FIGS. 2A to 2C, a determination bit which is a bit value set in advance is set to 1 upon performing the line thinning. A first row of the rectangular area determination window wc1 is indicated by p0 to p8. In this case, one side of the rectangular area determination window wc1 has nine pixels.

The row unit connectivity count 202 calculates xor of a priority determination bit and p0, where xor refers to an exclusive OR. That is, a value of A xor B is 0 when A=B and 1 when A≠B.

Sxor0 which is xor of the determination bit and p0 is 1, since the determination bit is 1 and p0 is 0.

The row unit connectivity count 202 calculates Sxor1 which is xor of the p0 and p1. Sxor1 is 0 since p0 is 0 and p1 is 0.

The row unit connectivity count 202 repeats this calculation to calculate nine values of Sxor.

A calculation of cnt_b which is a sum of the calculated nine values of Sxor is executed. In an example of FIG. 2A, cnt_b is 1.

In this case, a sum of Sxor0 to Sxor8 is called lcount.

FIG. 2B is a diagram illustrating an example in which values of all pixels of a row to be determined are 1. As shown in FIG. 2B, every Sxor is 0 when all the pixels of the row to be determined are 1. Accordingly, cnt_b is 0.

FIG. 2C is a diagram illustrating an example in which some white pixels are present in a row to be determined. As shown in FIG. 2C, cnt_b is 2 since p2 xor p3 and p5 xor p6 are 1, respectively.

FIG. 3 is a diagram illustrating an example in which one side of the rectangular area determination window wc1 has thirteen pixels. As shown in FIG. 3, the row unit connectivity count 202 calculates thirteen values of cnt_b[0] from the upper side to the lower side and calculates thirteen values of cnt_b[2] from the lower side to the upper side.

In the example of FIG. 3, a horizontal line having six-pixel width is illustrated. In this case, cnt_b[0] and cnt_b[2] are all 3. In addition, cnt_b[1] and cnt_b[3] are 0 in line parts and 1 in parts other than the line parts.

The row unit connectivity count 202 outputs the calculated value of cnt_b[0] and the calculated value of cnt_b[2] to the upper side connectivity determiner 204 and the lower side connectivity determiner 205, respectively.

By the same operation of the row unit connectivity count 202, the column unit connectivity count 203 calculates thirteen values of cnt_b[1] from the left side to the right side and then calculates thirteen values of cnt_b[3] from the right side to the left side.

The column unit connectivity count 203 outputs the calculated value of cnt_b[1] and the calculated value of cnt_b[3] to the left side connectivity determiner 206 and the right side connectivity determiner 207, respectively.

FIG. 4 is a flowchart illustrating a sequence of calculating values of cnt_b in the row unit connectivity count 202. As shown in FIG. 4, in Act S201, the row unit connectivity count 202 initializes a counter i and cnt_b to 0, respectively. In Act S202, the row unit connectivity count 202 calculates Sxor0 which is xor of the determination bit and p0.

In Act S203, the row unit connectivity count 202 adds 1 to the counter i. In Act S204, the row unit connectivity count 202 determines whether the counter i is larger than 8. The value of 8 is a value when one side of the rectangular area determination window wc1 has nine pixels. For example, the value is 12 when one side of the rectangular area determination window wc1 has thirteen pixels. The row unit connectivity count 202 permits the process to proceed to Act S206 when a condition of i>8 is satisfied. Alternatively, when the condition of i>8 is not satisfied, the process proceeds to Act S205.

In Act S205, the row unit connectivity count 202 calculates xor of pi−1 as an (i−1)-th pixel and pi as an i-th pixel and substitutes a value with Sxori which is an i-th Sxor. Then, the process returns to Act S203.

In Act S206, the row unit connectivity count 202 calculates a sum from a 0-th Sxor to an 8-th Sxor and substitutes a value with cnt_b. In Act S207, the row unit connectivity count 202 outputs cnt_b.

The row unit connectivity count 202 repeatedly performs the processes of Act S201 to Act S207 by the number of pixels of one side in the rectangular area determination window wc1, calculates 4-bit cnt_b by the number of the pixels of one side in the rectangular area determination window wc1, and then outputs the value to the upper side connectivity determiner 204.

In addition, the row unit connectivity count 202 repeatedly performs the processes of Act S201 to Act S207 by the number of the pixels of one side in the rectangular area determination window wc1 from the lower side to the upper side of the rectangular area determination window wc1, calculates 4-bit cnt_b by the number of the pixels of one side in the rectangular area determination window wc1, and then outputs the calculated value to the lower side connectivity determiner 205.

The column unit connectivity count 203 performs the cnt_b calculating operation of the row unit connectivity count 202 from the left side to the right side of the rectangular area determination window wc1 and outputs the calculated value to the left side connectivity determiner 206. In addition, the column unit connectivity count 203 performs the cnt_b calculating operation from the right side to the left side of the rectangular area determination window wc1 and outputs the calculated value to the right side connectivity determiner 207.

### (Connectivity Determiner)

The upper side connectivity determiner 204, the lower side connectivity determiner 205, the left side connectivity determiner 206, and the right side connectivity determiner 207 each input cnt_b, determine the connectivity, and output cnnct_b as the determination result.

FIG. 5 is a diagram illustrating a determination method of the upper side connectivity determiner 204. In this case, a connectivity determination window wd is a square area containing the attention pixel 33 of the image processing window Wa at the center. One side of the connectivity determination window wd has seven pixels in FIG. 5, for example.

The upper side connectivity determiner 204 outputs cnnct_b[0]=1 as a connectivity determination value to b4 of a determination result connector 209, when the values of cnt_b are all 1 or less. The upper side connectivity determiner 204 outputs cnnct_b[0]=0 to b4 of the determination result connector 209, when at least one of the values of cnt_b is 2 or more.

In an example of FIG. 5, a value of cnnct_b[0] is 0, since cnt_b having the value of 3 is present.

FIG. 6 is a diagram illustrating a determination method of the lower side connectivity determiner 205. In this case, a connectivity determination window wd is a square area containing the attention pixel 33 of the image processing window Wa at the center. One side of the connectivity determination window wd has seven pixels in FIG. 6, for example.

The lower side connectivity determiner 205 outputs cnnct_b[2]=1 as a connectivity determination value to b6 of the determination result connector 209, when the values of cnt_b are all 1 or less. The lower side connectivity determiner 205 outputs cnnct_b[2]=0 to b6 of the determination result connector 209, when at least one of the values of cnt_b is 2 or more.

In the example of FIG. 6, a value of cnnct_b[2] is 0, since cnt_b having the value of 3 is present.

FIG. 7 is a diagram illustrating a determination method of the left side connectivity determiner 206. In this case, a connectivity determination window wd is a square area containing the attention pixel 33 of the image processing window Wa at the center. One side of the connectivity determination window wd has seven pixels in FIG. 7, for example.

The left side connectivity determiner 206 outputs cnnct_b[1]=1 as a connectivity determination value to b5 of the determination result connector 209, when the values of cnt_b are all 1 or less. The left side connectivity determiner 206 outputs cnnct_b[1]=0 to b5 of the determination result connector 209, when at least one of the values of cnt_b is 2 or more.

In the example of FIG. 7, a value of cnnct_b[0] is 1, since all the values of cnt_b are 1 or less.

FIG. 8 is a diagram illustrating a determination method of the right side connectivity determiner 207. In this case, a connectivity determination window wd is a square area containing the attention pixel 33 of the image processing window Wa at the center. One side of the connectivity determination window wd has seven pixels in FIG. 8, for example.

The right side connectivity determiner 207 outputs cnnct_b[3]=1 as a connectivity determination value to b7 of the determination result connector 209, when the values of cnt_b are all 1 or less. The right side connectivity determiner 207 outputs cnnct_b[3]=0 to b7 of the determination result connector 209, when at least one of the values of cnt_b is 2 or more.

In the example of FIG. 8, a value of cnnct_b[3] is 0, since cnt_b having the value of 2 is present.

The determination result connector 209 outputs 4-bit flagc of b4 to b7 to a line adjustment determiner 210.

### (Line Adjustment Processing Selection Table)

The upper side connectivity determiner 204, the lower side connectivity determiner 205, the left side connectivity determiner 206, the right side connectivity determiner 207 output lcount1, lcount3, lcount0, and lcount2 to the line adjustment processing selection table 208, respectively.

The line adjustment processing selection table 208 outputs cnt_b in accordance with a pattern of lcount0 to lcount3.

In FIG. 3, for example, the pattern is a six-pixel thick line when lcount0 to lcount3 are 3333333333333111100000011133333333333331110000001111. Accordingly, the value of 0101 in flagc is changed into 0111 and output the changed value to the line adjustment determiner 210. In addition, the switch bits are output to the line adjustment determiner 210.

In addition, the pattern is a five-pixel normal line when lcount0 to lcount3 are 3333333333333111100000111133333333333331111000001111. Accordingly, the value of 0101 in flagc is changed into 0110 and output the changed value to the line adjustment determiner 210. In addition, the switch bits are output to the line adjustment determiner 210.

When the switch bits are input, the line adjustment determiner 210 outputs flagc from the line adjustment processing selection table 208, instead of the output of the determination result connector 209.

Even regarding to the same flagc, the line adjustment processing selection table 208 outputs cnt_b corresponding to the pattern of lcount0 to lcount3 in this way in accordance with a table stored in advance.

FIG. 12 is the diagram illustrating a connection operation of a flag connection section 16. As shown in FIG. 12, the flag connection section 16 sets and outputs Ro as an output from the contour pixel extraction section 11, flagc[0] as an output of flagc from the first rectangular area connectivity determination section 151, and flagc[1] as an output of flagc from the second rectangular area connectivity determination section 152 to b8, b7 to b4, and b3 to b0, respectively.

### (Line Thinning Calculation Section)

The line thinning calculation section 13 includes a first line thinning calculator 131 to an eighth line thinning calculator 138. The line thinning calculation section 13 inputs binarization values of pixels including the contour pixel extraction window 32 and creates filter coefficients in accordance with the patterns of the contour pixel extraction window 32.

The filter coefficients are different in the first line thinning calculator 131 to the eighth line thinning calculator 138. For example, the first line thinning calculator 131 to the eighth line thinning calculator 138 create the respective filter coefficients so that the first line thinning calculator 131 to the eighth line thinning calculator 138 perform the line thinning more in sequence and output SFILOUT 1 to SFILOUT 8 as the filter coefficients to a selector 141 of the selective correction output section 14.

The selector 141 outputs 0 and SFILOUT 1 to SFILOUT 8 selectively as SELOPUT to an addition portion 142 in accordance with the input from the flag connection section 16.

FIG. 13 is the diagram illustrating an example of filter selection of the selector 141. In FIG. 13, only flagc[0] is illustrated for convenient explanation. In addition, the number of filter coefficients is five.

As shown in FIG. 13, the selector 141 does not perform the line thinning when flagc[0] is 0000, for example, and selects the filter coefficient so as to delete more by enlarging an intensity of reduction filter when flagc[0] is 1011.

That is, the selector 141 selects the filter coefficient in such a manner of cutting a thick line part and an inner part of the thick line much, cutting a normal line by a midway degree, and cutting a thin line part a little.

The addition portion 142 outputs an addition of the attention pixel 33 and SELOUT to a multiplication portion 143. The multiplication portion 143 multiplies a value input from the addition portion 142 by a duty DTY to perform the line thinning and outputs the obtained value as an image signal SHW1.

### Advantage of Second Embodiment

As described above, the image processing apparatus according this embodiment includes the line adjustment processing selection table 208 which outputs cnt_b corresponding to the pattern of lcount0 to lcount3 in accordance with the table stored in advance. Accordingly, with the image processing apparatus according to this embodiment, it is possible to obtain an advantage of controlling the line thinning more precisely.

### Third Embodiment

The same reference numerals are given to the same constituent elements as those in the first embodiment and the detailed description is omitted. A difference between this embodiment and the first embodiment is a configuration and an operation of the rectangular area connectivity determination section 15.

### (Rectangular Area Connectivity Determination Section)

The rectangular area connectivity determination section 15 determines connectivity in a rectangular area determination window wc and outputs the result. The rectangular area determination window wc can be expressed as a square which contains the attention pixel 33 of the image processing window Wa at the center and of which one side has an odd number of pixels. One side of the rectangular area determination window wc can use areas having different sizes such as seven pixels or thirteen pixels.

In this embodiment, a first rectangular area connectivity determination section 151 uses a rectangular area determination window wc1 of which one side has thirteen pixels and a second rectangular area connectivity determination section 152 uses a rectangular area determination window wc2 of which one side has seven pixels.

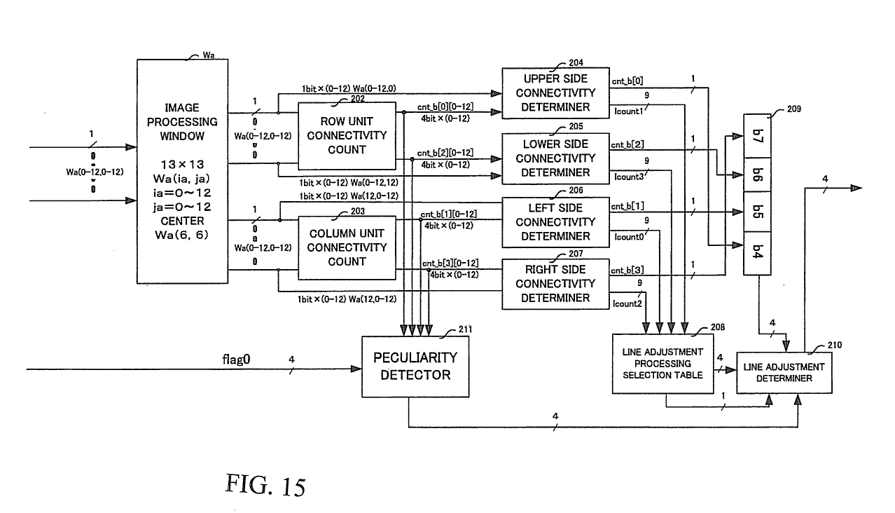

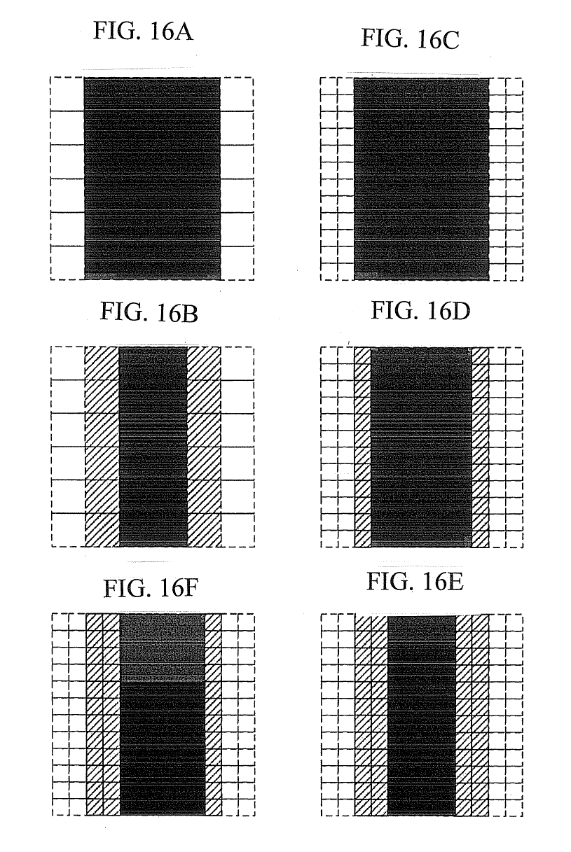

FIG. 15 is a block diagram illustrating an overview of the rectangular area connectivity determination section 15. The first rectangular area connectivity determination section 151 has the same configuration as that of the second rectangular area connectivity determination section 152, except that the size of the rectangular area connectivity determination window wc1 is different from that of the rectangular area connectivity determination window wc2. Hereinafter, the first rectangular area connectivity determination section 151 will be described as an example.

As shown in FIG. 15, the first rectangular area connectivity determination section 151 includes a row unit connectivity count 202, a column unit connectivity count 203, an upper side connectivity determiner 204, a lower side connectivity determiner 205, a left side connectivity determiner 206, a right side connectivity determiner 207, a line adjustment determiner 210, a line adjustment processing selection table 208, and a peculiarity detector 211. Hereinafter, the above elements will be described.

### (Row Unit Connectivity Count and Column Unit Connectivity Count)

The row unit connectivity count 202 inputs a signal from the image processing window Wa. The row unit connectivity count 202 determines connectivity of rows from the input signal and outputs the result.

FIG. 2A is a diagram illustrating a method of processing connectivity determination. In FIGS. 2A to 2C, a determination bit which is a bit value set in advance is set to 1 upon performing the line thinning. A first row of the rectangular area determination window wc1 is indicated by p0 to p8. In this case, one side of the rectangular area determination window wc1 has nine pixels.

The row unit connectivity count 202 calculates xor of a priority determination bit and p0, where xor refers to an exclusive OR. That is, a value of A xor B is 0 when A=B and 1 when A≠B.

Sxor0 which is xor of the determination bit and p0 is 1, since the determination bit is 1 and p0 is 0.

The row unit connectivity count 202 calculates Sxor1 which is xor of the p0 and p1. Sxor1 is 0 since p0 is 0 and p1 is 0.

The row unit connectivity count 202 repeats this calculation to calculate nine values of Sxor.

A calculation of cnt_b which is a sum of the calculated nine values of Sxor is executed. In an example of FIG. 2A, cnt_b is 1.

In this case, a sum of Sxor0 to Sxor8 is called lcount.

FIG. 2B is a diagram illustrating an example in which values of all pixels of a row to be determined are 1. As shown in FIG. 2B, every Sxor is 0 when all the pixels of the row to be determined are 1. Accordingly, cnt_b is 0.

FIG. 2C is a diagram illustrating an example in which some white pixels are present in a row to be determined. As shown in FIG. 2C, cnt_b is 2 since p2 xor p3 and p5 xor p6 are 1, respectively.

FIG. 3 is a diagram illustrating an example in which one side of the rectangular area determination window wc1 has thirteen pixels. As shown in FIG. 3, the row unit connectivity count 202 calculates thirteen values of cnt_b[0] from the upper side to the lower side and calculates thirteen values of cnt_b[2] from the lower side to the upper side.

In the example of FIG. 3, a horizontal line having six-pixel width is illustrated. In this case, cnt_b[0] and cnt_b[2] are all 3. In addition, cnt_b[1] and cnt_b[3] are 0 in line parts and 1 in parts other than the line parts.

The row unit connectivity count 202 outputs the calculated value of cnt_b[0] and the calculated value of cnt_b[2] to the upper side connectivity determiner 204 and the lower side connectivity determiner 205, respectively.

By the same operation of the row unit connectivity count 202, the column unit connectivity count 203 calculates thirteen values of cnt_b[1] from the left side to the right side and then calculates thirteen values of cnt_b[3] from the right side to the left side.

The column unit connectivity count 203 outputs the calculated value of cnt_b[1] and the calculated value of cnt_b[3] to the left side connectivity determiner 206 and the right side connectivity determiner 207, respectively.

FIG. 4 is a flowchart illustrating a sequence of calculating values of cnt_b in the row unit connectivity count 202. As shown in FIG. 4, in Act S201, the row unit connectivity count 202 initializes a counter i and cnt_b to 0, respectively. In Act S202, the row unit connectivity count 202 calculates Sxor0 which is xor of the determination bit and p0.

In Act S203, the row unit connectivity count 202 adds 1 to the counter i. In Act S204, the row unit connectivity count 202 determines whether the counter i is larger than 8. The value of 8 is a value when one side of the rectangular area determination window wc1 has nine pixels. For example, the value is 12 when one side of the rectangular area determination window wc1 has thirteen pixels. The row unit connectivity count 202 permits the process to proceed to Act S206 when a condition of i>8 is satisfied. Alternatively, when the condition of i>8 is not satisfied, the process proceeds to Act S205.

In Act S205, the row unit connectivity count 202 calculates xor of pi−1 as an (i−1)-th pixel and pi as an i-th pixel and substitutes a value with Sxori which is an i-th Sxor. Then, the process returns to Act S203.

In Act S206, the row unit connectivity count 202 calculates a sum from a 0-th Sxor to an 8-th Sxor and substitutes a value with cnt_b. In Act S207, the row unit connectivity count 202 outputs cnt_b.

The row unit connectivity count 202 repeatedly performs the processes of Act S201 to Act S207 by the number of pixels of one side in the rectangular area determination window wc1, calculates 4-bit cnt_b by the number of the pixels of one side in the rectangular area determination window wc1, and then outputs the value to the upper side connectivity determiner 204.

In addition, the row unit connectivity count 202 repeatedly performs the processes of Act S201 to Act S207 by the number of the pixels of one side in the rectangular area determination window wc1 from the lower side to the upper side of the rectangular area determination window wc1, calculates 4-bit cnt_b by the number of the pixels of one side in the rectangular area determination window wc1, and then outputs the calculated value to the lower side connectivity determiner 205.

The column unit connectivity count 203 performs the cnt_b calculating operation of the row unit connectivity count 202 from the left side to the right side of the rectangular area determination window wc1 and outputs the calculated value to the left side connectivity determiner 206. In addition, the column unit connectivity count 203 performs the cnt_b calculating operation from the right side to the left side of the rectangular area determination window wc1 and outputs the calculated value to the right side connectivity determiner 207.

### (Connectivity Determiner)

The upper side connectivity determiner 204, the lower side connectivity determiner 205, the left side connectivity determiner 206, and the right side connectivity determiner 207 each input cnt_b, determine the connectivity, and output cnnct_b as the determination result.

FIG. 5 is a diagram illustrating a determination method of the upper side connectivity determiner 204. In this case, a connectivity determination window wd is a square area containing the attention pixel 33 of the image processing window Wa at the center. One side of the connectivity determination window wd has seven pixels in FIG. 5, for example.

The upper side connectivity determiner 204 outputs cnnct_b[0]=1 as a connectivity determination value to b4 of a determination result connector 209, when the values of cnt_b are all 1 or less. The upper side connectivity determiner 204 outputs cnnct_b[0]=0 to b4 of the determination result connector 209, when at least one of the values of cnt_b is 2 or more.

In an example of FIG. 5, a value of cnnct_b[0] is 0, since cnt_b having the value of 3 is present.

FIG. 6 is a diagram illustrating a determination method of the lower side connectivity determiner 205. In this case, a connectivity determination window wd is a square area containing the attention pixel 33 of the image processing window Wa at the center. One side of the connectivity determination window wd has seven pixels in FIG. 6, for example.

The lower side connectivity determiner 205 outputs cnnct_b[2]=1 as a connectivity determination value to b6 of the determination result connector 209, when the values of cnt_b are all 1 or less. The lower side connectivity determiner 205 outputs cnnct_b[2]=0 to b6 of the determination result connector 209, when at least one of the values of cnt_b is 2 or more.

In the example of FIG. 6, a value of cnnct_b[2] is 0, since cnt_b having the value of 3 is present.

FIG. 7 is a diagram illustrating a determination method of the left side connectivity determiner 206. In this case, a connectivity determination window wd is a square area containing the attention pixel 33 of the image processing window Wa at the center. One side of the connectivity determination window wd has seven pixels in FIG. 7, for example.

The left side connectivity determiner 206 outputs cnnct_b[1]=1 as a connectivity determination value to b5 of the determination result connector 209, when the values of cnt_b are all 1 or less. The left side connectivity determiner 206 outputs cnnct_b[1]=0 to b5 of the determination result connector 209, when at least one of the values of cnt_b is 2 or more.

In the example of FIG. 7, a value of cnnct_b[0] is 1, since all the values of cnt_b are 1 or less.

FIG. 8 is a diagram illustrating a determination method of the right side connectivity determiner 207. In this case, a connectivity determination window wd is a square area containing the attention pixel 33 of the image processing window Wa at the center. One side of the connectivity determination window wd has seven pixels in FIG. 8, for example.

The right side connectivity determiner 207 outputs cnnct_b[3]=1 as a connectivity determination value to b7 of the determination result connector 209, when the values of cnt_b are all 1 or less. The right side connectivity determiner 207 outputs cnnct_b[3]=0 to b7 of the determination result connector 209, when at least one of the values of cnt_b is 2 or more.

In the example of FIG. 8, a value of cnnct_b[3] is 0, since cnt_b having the value of 2 is present.

The determination result connector 209 outputs 4-bit flagc of b4 to b7 to a line adjustment determiner 210.

### (Line Adjustment Processing Selection Table)

The upper side connectivity determiner 204, the lower side connectivity determiner 205, the left side connectivity determiner 206, the right side connectivity determiner 207 output lcount1, lcount3, lcount0, and lcount2 to the line adjustment processing selection table 208, respectively.

The line adjustment processing selection table 208 outputs cnt_b in accordance with a pattern of lcount0 to lcount3.

In FIG. 3, for example, when lcount0 to lcount3 denote a six-pixel thick line, the value of 0101 in flagc is changed into 0111 and output the changed value to the line adjustment determiner 210. In addition, the switch bits are output to the line adjustment determiner 210.

In addition, when lcount0 to lcount3 denote a five-pixel normal line, the value of 0101 in flagc is changed into 0110 and output the changed value to the line adjustment determiner 210. In addition, the switch bits are output to the line adjustment determiner 210.

When the switch bits are input, the line adjustment determiner 210 outputs flagc from the line adjustment processing selection table 208, instead of the output of the determination result connector 209.

Even regarding to the same flagc, the line adjustment processing selection table 208 outputs cnt_b corresponding to the pattern of lcount0 to lcount3 in this way in accordance with a table stored in advance.

### (Peculiarity Detector)

FIG. 9 is a diagram illustrating a round dot shown in the image processing window Wa. FIG. 10 is a diagram illustrating a result of the line thinning performed on the drawing of FIG. 9 by a known method. As shown in FIG. 10, a figure subjected to the line thinning by the known method does not become round and becomes protrusive in upward, downward, right, and left directions.

In this embodiment, a peculiarity of the figure in which such a phenomenon occurs is detected and flagc is forcedly switched to make the line of the figure thin more smoothly.

The row unit connectivity count 202 outputs cnt_b[0] and cnt_b[2] to the peculiarity detector 211. The column unit connectivity count 203 outputs cnt_b[1] and cnt_b[3] to the peculiarity detector 211.

On the other hand, the peculiarity detector 211 stores the peculiarity and peculiarity patterns which are patterns of cnt_b. FIG. 11A is a diagram illustrating examples of the peculiarity and patterns of cnt_b.

The peculiarity detector 211 sequentially reads the peculiarity patterns and compares the peculiarity patterns and cnt_b, when the peculiarity detector 211 receives an input of cnt_b. As a comparison method, the logical AND may be used.

In the example of FIG. 9, the rectangular area determination window wc1 is the same as a tenth peculiarity pattern. Accordingly, the peculiarity detector 211 determines that a peculiarity is present in the image processing window Wa.

The peculiarity detector 211 outputs predetermined flagc when the peculiarity detector 211 determines that the peculiarity is present. For example, when the peculiarity is detected, 1101 is output as flagc.

When the peculiarity detector 211 inputs the value, the line adjustment determiner 210 outputs the value output from the peculiarity detector 211 as flagc, instead of a value input from the determination result connector 209, regardless of the input of the switch bit from the line adjustment processing selection table 208.

For example, when an input from the determination result connector 209 is 0010, the peculiarity detector 211 outputs 1101. At this time, since 1101 is higher than 0010 in terms of connectivity, the line thinning calculation section 13 described below deletes more pixels. In this way, the protruding part of the peculiarity is removed and thus becomes a more smooth thin line.

FIG. 11B is a diagram illustrating the result of the line thinning in accordance with the output of the peculiarity detector 211. As shown in FIG. 11B, the tenth peculiarity pattern in FIG. 11A, an eleventh peculiarity pattern in FIG. 11A, a twelfth peculiarity pattern in FIG. 11A, and a thirteenth peculiarity pattern in FIG. 11A are subjected to the line thinning to be a tenth figure in FIG. 11B, an eleventh figure in FIG. 11B, a twelfth figure in FIG. 11B, and a thirteenth figure in FIG. 11B, respectively.

FIG. 12 is a diagram illustrating a connection operation of a flag connection section 16. As shown in FIG. 12, the flag connection section 16 sets and outputs Ro as an output from the contour pixel extraction section 11, flagc[0] as an output of flagc from the first rectangular area connectivity determination section 151, and flagc[1] as an output of flagc from the second rectangular area connectivity determination section 152 to b8, b7 to b4, and b3 to b0, respectively.

### (Line Thinning Calculation Section)

The line thinning calculation section 13 includes a first line thinning calculator 131 to an eighth line thinning calculator 138. The line thinning calculation section 13 inputs binarization values of pixels including the contour pixel extraction window 32 and creates filter coefficients in accordance with the patterns of the contour pixel extraction window 32.

The filter coefficients are different in the first line thinning calculator 131 to the eighth line thinning calculator 138. For example, the first line thinning calculator 131 to the eighth line thinning calculator 138 create the respective filter coefficients so that the first line thinning calculator 131 to the eighth line thinning calculator 138 perform the line thinning more in sequence and output SFILOUT 1 to SFILOUT 8 as the filter coefficients to a selector 141 of the selective correction output section 14.

The selector 141 outputs 0 and SFILOUT 1 to SFILOUT 8 selectively as SELOUT to an addition portion 142 in accordance with the input from the flag connection section 16.

FIG. 13 is the diagram illustrating an example of filter selection of the selector 141. In FIG. 13, only flagc[0] is illustrated for convenient explanation. In addition, the number of filter coefficients is five.

As shown in FIG. 13, the selector 141 does not perform the line thinning when flagc[0] is 0000, for example, and selects the filter coefficient so as to delete more by enlarging an intensity of reduction filter when flagc[0] is 1011.

That is, the selector 141 selects the filter coefficient in such a manner of cutting a thick line part and an inner part of the thick line much, cutting a normal line by a midway degree, and cutting a thin line part a little.

The addition portion 142 outputs an addition of the attention pixel 33 and SELOUT to a multiplication portion 143. The multiplication portion 143 multiplies a value input from the addition portion 142 by a duty DTY to perform the line thinning and outputs the obtained value as an image signal SHW1.

### Advantage of Third Embodiment

As described above, the image processing apparatus according to this embodiment includes a peculiarity detector which detects the peculiarity and forcedly changes the flag which is a base of the filter selection. In addition, the image processing apparatus according to this embodiment includes the line adjustment processing selection table 208 which outputs cnt_b corresponding to the pattern of lcount0 to lcount3 in accordance with the table stored in advance. Accordingly, with the image processing apparatus according to this embodiment, it is possible to obtain an advantage of performing the line thinning while keeping the feature of a figure even though the figure has a peculiarity. In addition, with the image processing apparatus according to this embodiment, it is possible to obtain an advantage of controlling the line thinning more precisely.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. An image processing apparatus comprising:
a contour pixel extraction section which determines whether an attention pixel is a contour;
a line thinning calculation section which calculates an amount of line thinning performed on the attention pixel when the contour pixel extraction section determines that the attention pixel is the contour;
a rectangular area connectivity determination section which determines whether a pixel area containing the attention pixel is a predetermined pixel pattern; and
a selective correction output section which performs the line thinning on the attention pixel by the amount of line thinning when the rectangular area connectivity determination section determines that the pixel area containing the attention pixel is not the predetermined pixel pattern, and performs the line thinning on the attention pixel by an alternative amount of line thinning different from the amount of line thinning when the rectangular area connectivity determination section determines that the pixel area containing the attention pixel is the predetermined pixel pattern.

2. The image processing apparatus according to claim 1, wherein the rectangular area connectivity determination section comprises:
a row unit connectivity count which determines a continuous degree of row unit pixels in a predetermined area;
a column unit connectivity count which determines a continuous degree of column unit pixels in the predetermined area;
an upper side connectivity determiner which determines connectivity of pixels from an upper side to a lower side in the predetermined area;
a lower side connectivity determiner which determines connectivity of pixels from the lower side to the upper side in the predetermined area;
a left side connectivity determiner which determines connectivity of pixels from a left side to a right side in the predetermined area;
a right side connectivity determiner which determines connectivity of pixels from the right side to the left side in the predetermined area;
a peculiarity detector which determines whether a peculiarity which is a figure pattern needing subjected to the line thinning is present in the predetermined area on the basis of inputs from the row unit connectivity count and the column unit connectivity count, and which outputs a signal in accordance with the peculiarity; and
a line adjustment determiner which replaces outputs from the upper side connectivity determiner, the lower side connectivity determiner, the left side connectivity determiner, and the right side connectivity determiner with the signal input from the peculiarity detector.

3. The image processing apparatus according to claim 2, wherein the peculiarity detector sequentially reads features of the peculiarity stored in advance and detects the peculiarity by pattern matching between the features of the read peculiarity and the inputs from the row unit connectivity count and the column unit connectivity count.

4. The image processing apparatus according to claim 1, wherein the rectangular area connectivity determination section comprises:
a row unit connectivity count which determines a continuous degree of row unit pixels in a predetermined area;
a column unit connectivity count which determines a continous degree of column unit pixels in the predetermined area;
an upper side connectivity determiner which determines connectivity of pixels from an upper side to a lower side in the predetermined area;
a lower side connectivity determiner which determines connectivity of pixels from the lower side to the upper side in the predetermined area;
a left side connectivity determiner which determines connectivity of pixels from a left side to a right side in the predetermined area;
a right side connectivity determiner which determines connectivity of pixels from the right side to the left side in the predetermined area;
a line adjustment processing selection table which determines a line width of the predetermined area on the basis of inputs from the upper side connectivity determiner, the lower side connectivity determiner, the left side connectivity determiner, and the right side connectivity determiner, and which outputs a signal in accordance with the line width; and
a line adjustment determiner which replaces outputs from the upper side connectivity determiner, the lower side connectivity determiner, the left side connectivity determiner, and the right side connectivity determiner with the signal input from the line adjustment processing selection table.

5. The image processing apparatus according to claim 4, wherein the line adjustment processing selection table outputs the signal in accordance with a corresponding table of input values and output values from the upper side connectivity determiner, the lower side connectivity determiner, the left side connectivity determiner, and the right side connectivity determiner.

6. The image processing apparatus according to claim 1, wherein the rectangular area connectivity determination section comprises:
a row unit connectivity count which determines a continuous degree of row unit pixels in a predetermined area;
a column unit connectivity count which determines a continous degree of column unit pixels in the predetermined area;
an upper side connectivity determiner which determines connectivity of pixels from an upper side to a lower side in the predetermined area;
a lower side connectivity determiner which determines connectivity of pixels from the lower side to the upper side in the predetermined area;
a left side connectivity determiner which determines connectivity of pixels from a left side to a right side in the predetermined area;
a right side connectivity determiner which determines connectivity of pixels from the right side to the left side in the predetermined area;
a peculiarity detector which determines whether a peculiarity which is a figure pattern needing subjected to the line thinning is present in the predetermined area on the basis of inputs from the row unit connectivity count and the column unit connectivity count, and which outputs a signal in accordance with the peculiarity;
a line adjustment processing selection table which determines a line width of the predetermined area on the basis of inputs from the upper side connectivity determiner, the lower side connectivity determiner, the left side connectivity determiner, and the right side connectivity determiner, and which outputs a signal in accordance with the line width; and
a line adjustment determiner which replaces outputs from the upper side connectivity determiner, the lower side connectivity determiner, the left side connectivity determiner, and the right side connectivity determiner with the signal input from the line adjustment processing selection table, and which replaces the signal input from the line adjustment processing selection table and the outputs from the upper side connectivity determiner, the lower side connectivity determiner, the left side connectivity determiner, and the right side connectivity determiner with the signal input from the peculiarity detector.

7. The image processing apparatus according to claim 6,
wherein the peculiarity detector sequentially reads features of the peculiarity stored in advance and detects the peculiarity by pattern matching between the features of the read peculiarity and the inputs from the row unit connectivity count and the column unit connectivity count, and
wherein the line adjustment processing selection table outputs the signal in accordance with a corresponding table of input values and output values from the upper side connectivity determiner, the lower side connectivity determiner, the left side connectivity determiner, and the right side connectivity determiner.

8. The image processing apparatus according to claim 1, wherein the image processing apparatus includes a plurality of the rectangular area connectivity determination section.

9. The image processing apparatus according to claim 1, wherein the image processing apparatus includes a plurality of the line thinning calculation sections.

10. An image forming apparatus comprising an image processing apparatus comprising:
a contour pixel extraction section which determines whether an attention pixel is a contour and outputs the determination result;
a line thinning calculation section which calculates an amount of line thinning performed on the attention pixel when the contour pixel extraction section determines that the attention pixel is the contour;
a rectangular area connectivity determination section which determines whether a pixel area containing the attention pixel is a predetermined pixel pattern; and
a selective correction output section which performs the line thinning on the attention pixel by the amount of line thinning when the rectangular area connectivity determination section determines that the pixel area containing the attention pixel is not the predetermined pixel pattern, and performs the line thinning on the attention pixel by an alternative amount of line thinning different from the amount of line thinning when the rectangular area connectivity determination section determines that the pixel area containing the attention pixel is the predetermined pixel pattern.

11. The image forming apparatus according to claim 10, wherein the rectangular area connectivity determination section comprises:
a row unit connectivity count which determines a continuous degree of row unit pixels in a predetermined area;
a column unit connectivity count which determines a continous degree of column unit pixels in the predetermined area;
an upper side connectivity determiner which determines connectivity of pixels from an upper side to a lower side in the predetermined area;
a lower side connectivity determiner which determines connectivity of pixels from the lower side to the upper side in the predetermined area;
a left side connectivity determiner which determines connectivity of pixels from a left side to a right side in the predetermined area;
a right side connectivity determiner which determines connectivity of pixels from the right side to the left side in the predetermined area;
a peculiarity detector which determines whether a peculiarity which is a figure pattern needing subjected to the line thinning is present in the predetermined area on the basis of inputs from the row unit connectivity count and the column unit connectivity count, and which outputs a signal in accordance with the peculiarity; and
a line adjustment determiner which replaces outputs from the upper side connectivity determiner, the lower side connectivity determiner, the left side connectivity determiner, and the right side connectivity determiner with the signal input from the peculiarity detector.

12. The image forming apparatus according to claim 11, wherein the peculiarity detector sequentially reads features of the peculiarity stored in advance and detects the peculiarity by pattern matching between the features of the read peculiarity and the inputs from the row unit connectivity count and the column unit connectivity count.

13. The image forming apparatus according to claim 10, wherein the rectangular area connectivity determination section comprises:
a row unit connectivity count which determines a continuous degree of row unit pixels in a predetermined area;
a column unit connectivity count which determines a continous degree of column unit pixels in the predetermined area;
an upper side connectivity determiner which determines connectivity of pixels from an upper side to a lower side in the predetermined area;
a lower side connectivity determiner which determines connectivity of pixels from the lower side to the upper side in the predetermined area;
a left side connectivity determiner which determines connectivity of pixels from a left side to a right side in the predetermined area;
a right side connectivity determiner which determines connectivity of pixels from the right side to the left side in the predetermined area;
a line adjustment processing selection table which determines a line width of the predetermined area on the basis of inputs from the upper side connectivity determiner, the lower side connectivity determiner, the left side connectivity determiner, and the right side connectivity determiner, and which outputs a signal in accordance with the line width; and
a line adjustment determiner which replaces outputs from the upper side connectivity determiner, the lower side connectivity determiner, the left side connectivity determiner, and the right side connectivity determiner with the signal input from the line adjustment processing selection table.

14. The image forming apparatus according to claim 13, wherein the line adjustment processing selection table outputs the signal in accordance with a corresponding table of input values and output values from the upper side connectivity determiner, the lower side connectivity determiner, the left side connectivity determiner, and the right side connectivity determiner.

15. The image forming apparatus according to claim 10, wherein the rectangular area connectivity determination section comprises:
a row unit connectivity count which determines a continuous degree of row unit pixels in a predetermined area;
a column unit connectivity count which determines a continous degree of column unit pixels in the predetermined area;
an upper side connectivity determiner which determines connectivity of pixels from an upper side to a lower side in the predetermined area;
a lower side connectivity determiner which determines connectivity of pixels from the lower side to the upper side in the predetermined area;
a left side connectivity determiner which determines connectivity of pixels from a left side to a right side in the predetermined area;
a right side connectivity determiner which determines connectivity of pixels from the right side to the left side in the predetermined area;
a peculiarity detector which determines whether a peculiarity which is a figure pattern needing subjected to the peculiar line thinning is present in the predetermined area on the basis of inputs from the row unit connectivity count and the column unit connectivity count, and which outputs a signal in accordance with the peculiarity;
a line adjustment processing selection table which determines a line width of the predetermined area on the basis of inputs from the upper side connectivity determiner, the lower side connectivity determiner, the left side connectivity determiner, and the right side connectivity determiner, and which outputs a signal in accordance with the line width; and
a line adjustment determiner which replaces outputs from the upper side connectivity determiner, the lower side connectivity determiner, the left side connectivity determiner, and the right side connectivity determiner with the signal input from the line adjustment processing selection table, and which replaces the signal input from the line adjustment processing selection table and the outputs from the upper side connectivity determiner, the lower side connectivity determiner, the left side connectivity determiner, and the right side connectivity determiner with the signal input from the peculiarity detector.

16. The image forming apparatus according to claim 15,
wherein the peculiarity detector sequentially reads features of the peculiarity stored in advance and detects the peculiarity by pattern matching between the features of the read peculiarity and the inputs from the row unit connectivity count and the column unit connectivity count, and
wherein the line adjustment processing selection table outputs the signal in accordance with a corresponding table of input values and output values from the upper side connectivity determiner, the lower side connectivity determiner, the left side connectivity determiner, and the right side connectivity determiner.

17. The image forming apparatus according to claim 10, wherein the image forming apparatus includes a plurality of the rectangular area connectivity determination sections.

18. The image forming apparatus according to claim 10, wherein the image forming apparatus includes a plurality of the line thinning calculation sections.

19. A line thinning method of an image processing apparatus, wherein a selective correction output section replaces an amount of line thinning calculated by a line thinning calculation section in accordance with a contour determined by a contour pixel extraction section with an amount of line thinning corresponding to an alternative pixel pattern output when a rectangular area connectivity determination section determines that a pixel area containing an attention pixel is a predetermined pixel pattern.

20. The line thinning method according to claim 19,
wherein a peculiarity detector of the contour pixel extraction section sequentially reads features of the peculiarity stored in advance, detects the peculiarity by pattern matching between the features of the read peculiarity and inputs from the row unit connectivity count and the column unit connectivity count, and outputs a signal in accordance with the peculiarity, and
wherein a line adjustment processing selection table of the contour pixel extraction section outputs a signal in accordance with a corresponding table of input values and output values from the upper side connectivity determiner, the lower side connectivity determiner, the left side connectivity determiner, and the right side connectivity determiner.
